(19) United States
(12) Patent Application Publication
(10) Pub. No.: US 2022/0003618 A1
(43) Pub. Date: Jan. 6, 2022

(54) TORQUE SENSING SYSTEM

(71) Applicant: TRUEKINETIX B.V., Heemstede (NL)

(72) Inventor: Bas Jan Emile VAN RENS, Heemstede (NL)

(73) Assignee: TRUEKINETIX B.V., Heemstede (NL)

(21) Appl. No.: 17/281,298

(22) PCT Filed: Oct. 2, 2019
(86) PCT No.: PCT/NL2019/050661

§ 371 Date: Mar. 30, 2021

(30) Foreign Application Priority Data
Oct. 2, 2018 (NL) 2021749
Oct. 31, 2018 (NL) 2021908

(51) Int. Cl. G01L 5/00; A63B 22/06; A63B 22/00

(52) U.S. Cl. CPC G01L 5/0042; A63B 22/06; A63B 2220/58; A63B 2220/54; A63B 2220/51; A63B 22/0076

(57) ABSTRACT

This disclosure relates to a torque sensing system. The torque sensing system comprises a rotatable shaft (102) having a first part and a second part, the shaft comprising a spring structure (122) between the first and second part; a first readout structure (130) connected to the first part, the first readout structure (130) comprising first position indicators, and a second readout structure (132) connected to the second part, the second readout structure (132) comprising second position indicators; a detector system for detecting the first and second position indicators and generating a first detection signal indicating respective passing times for the first position indicators and a second detection signal indicating respective passing times for the second position indicators; and a processor. The processor is configured for determining an angular position of the first readout structure (130) occurring at a particular time instance based on a detected passing time of at least one first position indicator on the first readout structure (130) and on a first relation between angular position of the first readout structure (130) and time around said particular time instance; and determining an angular position of the second readout structure (132) occurring at the particular time instance based on a detected passing time of at least one second position indicator on the second readout structure (132) and optionally based on a second relation between angular position of the second readout structure (132) and time around said particular time instance; and, determining an angle of twist at the particular time instance based on the angular position of the first readout structure (130) and the angular position of the second readout structure (132), the angle of twist being associated with a torque applied to the first and/or second part of the rotatable shaft (102).

### FIELD OF THE INVENTION

The invention relates to a torque sensing system, and, in particular, though not exclusively, methods and devices for determining a torque for a force feedback system, for example a force feedback system for an exercise apparatus, a computer-controlled exercise apparatus comprising such torque sensing system, a torsion spring structure for such torque sensing system and a computer program product for executing such methods.

### BACKGROUND OF THE INVENTION

Force feedback systems are used to create forces in a mechanical system to simulate a real-life situation. For example, in modern exercise equipment the reality is mimicked using a force-feedback system applying some form of counter force to the motion of the athlete based on his current state, which is determined based on sensor information. Most commonly, the current state of the athlete is measured by sensors in terms of position, speed and force. Based on the sensor information a resistive force that the apparatus should provide is calculated by a computer and used to control an apparatus that is capable of generating a variable resistive force using mechanical, electrical and/or magnetic means. Typically, both during measurements and the calculation of the resistive force a considerable amount of averaging is applied to limit the speed at which the resistive forces change since large fluctuations in the resistive forces are difficult (expensive) to apply and can pose significant threat to the athlete.

U.S. Pat. No. 7,833,135 describes an example of an exercise apparatus, a spinning bike, including a computer-controlled force generating device which generates a resistive (braking) force based on a measured velocity (using an encoder coupled to the crank) and a measured force (e.g. using a force sensor). Based on a simple force equation (a kinetic model) the spinning bike can be modelled, wherein a computer may determine a computed velocity and compare the computed velocity with a measured velocity and control the generation of the resistive force on the basis of the difference between the calculated and the measured velocity. This way, a resistive force can be applied to the wheel of the bike to mimic the force experienced by an athlete on a real bike. The scheme described in U.S. Pat. No. 7,833,135 however does not provide an athlete with a true outdoor biking experience. For such experience, the resistive force needs to be determined on the basis of accurately measured sensor information, which is determined real time. The averaging of the measurements and the proposed sensors are not suitable for accurately determining sensor data at such high rates. The proposed force sensor is mounted on the crank and relies on changes in the intensity of a reflected optical analogous signal, which is very sensitive to noise. Further, the sample frequency of the sensor is limited due the fact that the optical signal is accessible via holes of in the crank set.

In the field of bicycles and electrical bicycles it is known to monitor the performance of a rider by measuring the torque and the power applied by a user to the axis of the crank. For example, WO2014/132021 describes a torque sensor for a bicycle which is configured to measure small deformations of the crank shaft due to the applied torque using two encoder wheels connected to both ends of the shaft, wherein the encoder wheels comprise 32 alternating teeth and gaps (readout elements) along the periphery of the wheel. The relative angular displacement (the angle of twist) between the two encoder wheels provides a measure of the applied torque as a function of time, wherein the maximum angle of twist that can be measured by such sensor is 360 degrees divided by the number of readout elements.

When using a torque sensor in a force feedback system for an exercise apparatus, high frequency feedback (>100 Hz) is needed in order to accurately generate reaction forces in the exercise equipment in which rotational speeds are of the order between 1-20 rpm. This is because for a stable force feedback system that is capable of responding to fast changes in forces applied to the exercise apparatus, the input of the feedback controller needs to receive values at a constant, high frequency rate. The prior art torque sensors are not suitable for that purpose. For example, the above-described prior art torque sensor would be able to process data at a sampling frequency of about 5 Hz. If high frequency feedback is needed, either the rotation speed needs to be high (e.g. 32 indicators at a rotational velocity of 190 rpm would result in a sampling frequency of around 100 Hz), or, alternatively, the number of readout elements may be increased substantially (e.g. 6 rpm and 1000 readout element still only yields a sampling frequency of 100 Hz).

However, both solutions have their drawbacks. High rotation speeds can yield accurate results with a few position indicators, by determining the time gap between two sides of the torque sensor, whilst allowing for a significant amount of averaging across position indicators. However, such a solution will work poorly at low speeds. On the other hand, low rotation speeds can yield accurate results provided that many position indicators are used and the exact position on either side of the sensor is known. For example, US2016/0116353 describes a torque sensor including a sensor disk including markers placed around the circumference of a disc. A high degree of resolution can be achieved using a large number 120,000 detectable markers on the disc. However, in an exercise apparatus the speed can be both low and high and the measurements need to be accurate in both cases. The use of a large number of markers at high speeds will introduce many challenges due to the overload of sensor data.

Hence, from the above it follows that there is a need in the art for an improved torque sensor and an improved computer-controlled force feedback system using such torque sensor. In particular, there is a need in the art for torque sensor that is capable of providing a high signal to noise ratio and high frequency feedback across a wide range of rotation speeds at acceptable cost which can be used in a force feedback system of an exercise apparatus that can provide a real-life exercise experience.

### SUMMARY OF THE INVENTION

It is an objective of the invention to reduce or eliminate at least one of the drawbacks known in the prior art.

In an aspect, this disclosure relates to a torque sensing system. The torque sensing system may comprise a rotatable shaft having a first part and a second part, the shaft comprising a spring structure between the first and second part; a first readout structure connected to the first part, the first readout structure comprising first position indicators, and a second readout structure connected to the second part, the second readout structure comprising second position indicators; a detector system for detecting the first and second position indicators and generating a first detection signal indicating respective passing times for the first position indicators and a second detection signal indicating respective passing times for the second position indicators. Here, the passing time may be defined as the time that a position indicator passes the detection zone of the detector system.

The torque sensing system may further comprise a processor configured for determining an angular position of the first readout structure occurring at a particular time instance based on a detected passing time of at least one first position indicator on the first readout structure and on a first relation between angular position of the first readout structure and time around said particular time instance; and determining an angular position of the second readout structure occurring at the particular time instance based on a detected passing time of at least one second position indicator on the second readout structure and, optionally, based on a second relation between angular position of the second readout structure and time around said particular time instance; and, determining an angle of twist at the particular time instance based on the angular position of the first readout structure and the angular position of the second readout structure, the angle of twist being associated with a torque applied to the first and/or second part of the rotatable shaft.

Since the processor can determine an angular position of the first resp. second readout structure at any arbitrary time instance (also at time instances at which no position indicator passes the detector system) it can output a high frequency signal. Here, a high frequency signal may be regarded as a signal that has, per unit of time, more values for the angular position of the first resp. second readout structure than the number of first resp. second position indicators that pass by the detector system per said unit of time. Such a high frequency signal allows high frequency feedback which for example improves the exercise experience.

In an embodiment, the processor is configured for determining said first relation and wherein the step of determining said first relation is performed based on at least two detected passing times of at least two respective first position indicators on the first readout structure, and wherein, optionally, the processor is configured for determining said second relation an wherein, optionally, the step of determining said second relation is performed based on at least two detected passing times of at least two respective second position indicators on the second readout structure.

This embodiment allows to accurately determine such relation between angular position and time. In one example, the system comprises a rotational speed detector that is configured to measure the rotational speed without requiring the position indicators. This rotational speed may be used as the above-mentioned relation between angular position and time.

In an embodiment, said first relation and, optionally, said second relation is a linear relation between angular position and time.

In an embodiment, the first readout structure comprises a first reference indicator and the detector system is suitable for detecting the first reference indicator. In this embodiment, the step of determining said angular position of the first readout structure occurring at said particular time instance comprises counting a number of first position indicators that pass by since a detected passing time of the first reference indicator, and wherein, optionally, the second readout structure comprises a second reference indicator and the detector system is suitable for detecting the second reference indicator and wherein the step of determining said angular position of the second readout structure occurring at said particular time instance optionally comprises counting a number of second position indicators that pass by since a detected passing time of the second reference indicator.

This embodiment obviates the need to use absolute angular position encoders, which requires many detectors to detect each code and high processing capabilities.

In an embodiment, the particular time instance lies between two detected passing times of two respective first position indicators, preferably the angular position of the first readout structure being determined based on said two detected passing times, or wherein the particular time instance lies after the most recently detected passing time of a first position indicator.

In the former alternative, as stated, preferably an interpolation is used to determine the angular position of the first readout structure. In the latter alternative, an extrapolation may be used to determine the angular position of the first readout structure.

In an embodiment, t the first or second part of the rotatable shaft is rotationally fixed herewith defining a fixed angular position of the first respectively second readout structure.

In an embodiment, the detector system comprises one or more imaging sensors for imaging the position indicators and/or an optical detector and/or an magnetic detector and/or a capacitive detector.

One aspect of this disclosure relates to a computer-implemented method for determining an angle of twist, wherein a torque sensing system comprises a rotatable shaft has a first part and a second part, the shaft comprising a spring structure between the first and second part; and wherein the torque sensing system comprises a first readout structure connected to the first part, the first readout structure comprising first position indicators, and a second readout structure connected to the second part, the second readout structure comprising second position indicators; and wherein the torque sensing system comprises a detector system for detecting the first and second position indicators and generating a first detection signal indicating respective passing times for the first position indicators and a second detection signal indicating respective passing times for the second position indicators; the computer-implemented method comprising, receiving said first and second detection signal from the detector system; determining an angular position of the first readout structure occurring at a particular time instance based on a detected passing time of at least one first position indicator on the first readout structure and on a first relation between angular position of the first readout structure and time around said particular time instance; determining an angular position of the second readout structure occurring at the particular time instance based on a detected passing time of at least one second position indicator on the second readout structure and optionally based on a second relation between angular position of the second readout structure and time around said particular time instance; and, determining an angle of twist at the particular time instance based on the angular position of the first readout structure and the angular position of the second readout structure, the angle of twist being associated with a torque applied to the first and/or second part of the rotatable shaft.

One aspect of this disclosure relates to a computer program product comprising software code portions configured for, when run in the memory of a computer, executing the above-mentioned computer implemented method.

In an aspect, the invention relates to a torque sensing system comprising: a rotatable shaft having a first part and a second part, where at least one part of the shaft is rotatable under an external load, the shaft comprising a spring structure between the first and second part; a readout structure connected to the rotatable part of the shaft, the readout structure comprising position indicators; an encoder system configured to measure a first absolute rotary position of the first part of the shaft based on the first position indicators; a means to determine the absolute rotary position of the first and second part at position on or between the position indicators; wherein in response to an external force to the first, the change in the first absolute rotary position measured by the encoding system determines an angle of twist which is a measure for the torque in the system.

In another aspect, the invention may relate to a torque sensing system comprising: a shaft having a first part and a second part, wherein at least one part of the shaft is rotatable under an external load, the shaft comprising a spring structure between the first and second part; a readout structure connected to the rotatable part comprising position indicators and a reference indicator; a detector system for detecting position indicators moving through a detection zone of the detector system; and, a computer system configured for: determining an angular reference position of the readout structure based on detection of the reference indicator; measuring angular positions of the readout structure and time instances associated with the angular positions based on detection of position indicators, the angular positions of the readout structure being determined relative to the angular reference position; using a first time instance of a first angular position of the readout structure and a second time instance of a second angular position of the readout structure to predict a further angular position of the readout structure at a further time instance that is later in time than the first and second time instance; and, determining an angle of twist based the further angular position of the readout structure, the angle of twist being associated with a torque applied to the rotatable part of the shaft.

In another aspect the invention relates to a torque sensing system comprising: a rotatable shaft having a first part and a second part, where at least one part of the shaft can rotate under an external load, the shaft comprising a spring structure between the first and second part; a first readout structure connected to the first part comprising first position indicators and/or a second readout structure connected to the second part comprising a second position indicators; an encoder system configured to measure a first absolute rotary position of the first part of the shaft based on the first position indicators and a second absolute rotary position based on the second position indicators; a means to determine the absolute rotary position of the first and second part at position on or between the position indicators; wherein in response to an external force to the first and/or second part, the difference between a first and second absolute rotary position measured by the encoding system determining an angle of twist.

Thus, absolute rotary positions of two parts of a rotatable shaft are measured based on position indicators on a readout structure connected to the shaft, so that an angle of twist can be determined which correlates with an external force (a torque) that is applied to the shaft at each time instance. Because the encoder system is configured to measure an absolute rotary position of both readout structures, the relative shift between the position indicators may be larger than the rotational angle between two subsequent position indicators of the first readout structure or the second readout structure.

Here, the term position indicator may include any means that can be detected or imaged and used to determine an absolute rotary position of the shaft. A position indicator may include one or more optically, magnetically, mechanically and/or magnetically elements which can be detected by a suitable detector or camera.

In an embodiment, the spring structure may be configured to provide a maximum angle of twist which is larger than the rotary angle between two subsequent position indicators of the first and second readout structure. The external force will induce a reversible torsional deformation in the spring structure of the shaft, wherein the spring structure is configured such that the relative rotational shift between the position indicators of the readout structures (e.g. the difference between the first and second absolute rotary position) of the readout structures connected to the first and second part of the shaft can be larger than the rotational angle between two position indicators. This way, a large signal to noise ratio can be obtained.

In an embodiment, the spring structure may be configured to provide an angle of twist between −20 and 20 degrees. In another embodiment, the angle of twist may be between −10 and 10 degrees.

In an embodiment, the spring structure may comprise a torsion spring, preferably a spiral torsion spring. Such as spring structure may be used to address the problem of realizing a shaft structure that exhibits large torsion angles. Such spiral torsion spring structure allows a compact spring structure which provides a substantial angle of twist in response to the externally applied force.

In an embodiment, first readout structure may comprise at least a first reference indicator, wherein the encoder system is further configured to determine an absolute rotary position of the first reference indicator and to determine an absolute position of at least one of the plurality of position indicators based on the absolute position of the first reference indicator. In this embodiment, the reference position of a reference indicator is determined. As the position of the reference indicator relative to the position indicators is accurately known, the absolute position of each position indicators can be determined. Here, the term reference indicator may include any means that can be detected or imaged and used to determine an absolute reference (rotary) position of the shaft. Similar to a position indicator, a reference indicator may include one or more optically, mechanically, capacitively and/or magnetically elements which can be detected by a suitable detector or camera.

In an embodiment, each of the first position indicators may be associated with unique code (e.g. one or more markers, numbers, symbols, coded slots or combinations thereof). In an embodiment, the encoder system may be further configured to determine an absolute rotary position for each position indicated based on the associated unique code. In an embodiment, the encoder system may include a memory comprising a lookup table comprising the unique codes and rotary position of the position indicators. In another embodiment, the encoder system may include module for executing an algorithm that provides a functional relation between the unique codes and rotary positions of the position indicators. In this embodiment, each position indicator is associated with a unique code which provides a direct measure of the absolute rotary position of the position indicator.

In another embodiment, the first readout structure may include a disc connected to the first part of the shaft wherein the first position indicators are positioned along the periphery of the disc; and/or, wherein the second readout structure includes a second disc connected to the second part of the shaft, wherein the second position indicators are positioned along the periphery of the second disc.

In an embodiment, the encoder system may include one or more detectors for detecting the position indicators. In another embodiment, the encoder system may include one or more imaging sensors for imaging the position indicators. Further, a processor in the encoder system may be configured to analyse images and determine positions of the position indicators based on known image analysis techniques.

In a further aspect, the invention may relate to a feedback system for an exercise apparatus comprising a torque sensing system according to any of the embodiments described above.

In an embodiment, the feedback system may include a force generating device connected to the second part of the rotatable shaft and a computer comprising a processor configured to: in response to a first torque applied to the first part of the rotatable shaft; receiving from the torque sensing system first absolute position information of the first part of the rotatable shaft and second absolute position information of the second part of the rotatable shaft; using the first and second absolute position information to compute an angle of twist between the first part and second part of the shaft; and, computing a control signal for the force generating device, the control signal instructing the force generating device to exert a second torque to the second end of the shaft, the second torque being opposite to the first torque.

In an aspect, the invention may relate to a computer-controlled exercise apparatus comprising: a frame; a shaft rotatable mounted to the frame; at least one force receiving structure rotatably connected to a first part of the rotatable shaft; and, a force generating device connected to the second part of the rotational shaft; an encoder system configured to measure first absolute position information of the first part of the rotatable shaft and to measure second absolute position information of the second part of the rotatable shaft, the first and second position information being generated by the encoder system in response to a user of the exercise apparatus applying a force to the force receiving structure, the force exerting a first torque to the first part of the rotatable shaft; and, a force feedback system including a computer-controlled force generating device rotatable connected to the second part of the shaft and a processor of a computer configured to determine an angle of twist between the first and second part of the shaft on the basis of the first and second absolute position information and to control the force generating device to exert a second torque to the second part of the shaft, based on the first and second position information, the second torque being opposite to the first torque.

In an embodiment, the computer-controlled exercise may further comprise: a first readout structure connected to the first part comprising first position indicators and a second readout structure connected to the second part comprising a second position indicators; wherein the encoder system is configured to measure first absolute position information based on the first position indicators and the second absolute position information based on the second position indicators.

In an embodiment, the exercise apparatus may be a stationary exercise bicycle. In an embodiment, the rotatable shaft may be the rear axis of the exercise bicycle or being rotatable connected to the rear axis of the exercise bicycle. In another embodiment, the first part of the rotatable shaft may be connected to a gear, wherein a transmission system, preferably including a chain or a band, may connect the gear to a crank

In an embodiment, the rotatable shaft may include a torsion spring structure in the shape of a spiral rotary spring, wherein the spiral rotary spring being may be contained in a (circular) enclosure, the spiral rotary spring including an outer end connected to the outer enclosure, the outer enclosure being connected to the first part of the shaft and the spiral rotary spring including an inner end connected to the second part of the shaft.

In an embodiment, the processor of the force feedback system may use an algorithm based on a kinematic model of the exercise apparatus to determine a value of the second torque using the angle of twist as input information.

In an aspect, the invention relates to a torque sensing system comprising: a rotatable shaft having a first part and a second part, the shaft comprising a deformable spring structure between the first and second part; a first readout structure connected to the first part comprising a plurality of first position indicators and a second readout structure connected to the second part comprising a plurality of second position indicators; an encoder system configured to measure a first rotatory position of the first part of the shaft based on the plurality of first position indicators and a first reference indicator and a second rotary position based on the plurality of second position indicators and a second reference indicator; and, wherein in response to a first torque applied to the first part and a second torque applied to the second part, the second torque having direction opposite to the first torque, the spring structure providing a relative shift in the rotary position between the first and second part, the first and second absolute rotary position measured by the encoder system defining an angle of twist of the shaft.

Since the angle of twist is computed based on the absolute rotational position the first and second part of the shaft, the measured angle is independent of the spatial angle between both indicators. This way, it is possible to measure angle of twists that substantially larger than the angle between two subsequent position indicators.

In an embodiment, the spring structure is configured such that the maximum angle of twist provided by the spring structure in response to the external force is larger than the rotary angle defined as the angle between two subsequent position indicators of the first and second readout structure.

In an embodiment, the plurality of first position indicators and the first reference indicator may form a first readout structure, preferably a readout structure in the form of a disc wherein the plurality of first position indicators are positioned along the periphery of the disc, connected to the first part of the shaft and wherein the plurality of second position indicators and the second reference indictor may form a second readout structure, preferably a readout structure in the form of a disc wherein the plurality of second position indicators are positioned along the periphery of the disc, connected to the second part of the shaft.

In an aspect, the invention relates to a force feedback system comprising a torque sensing system as described above.

In a further aspect, the invention relates to an apparatus comprising a force feedback system comprising a torque sensing system as described above.

In an embodiment, the invention may relate to a torsion spring structure for a torque sensing system of an exercise apparatus as described in this application wherein the structure may comprise a rotatable shaft wherein a coupling structure connects a first part of the shaft to a second part of the shaft, and wherein the coupling structure may comprise one or more (spiral) rotary torsion spring structures, compression spring structures and/or a (visco)elastic spring structures.

In an embodiment, the torsion spring structure may be contained in a circular enclosure, the torsion spring including an outer end connected to the outer enclosure, the outer enclosure being connected to the first part of the shaft and the torsion spring including an inner end connected to the second part of the shaft.

In an aspect, the invention relates to a method of controlling a force feedback system of an exercise apparatus. In an embodiment, the method may comprise: a processor receiving at least one signal from an encoder system, the encoder system being configured to measure first position information of a first part of a rotatable shaft and a second position information of a second part of the rotatable shaft of an exercise apparatus, the signal being generated by the encoder system in response to an external force, e.g. a user of the exercise apparatus applying at least a first torque to the first part of the rotatable shaft; the processor using the first second position information and second position information in the at least one encoder signal to compute an angle of twist between the first part and second part of the shaft; and, using the angle of twist to compute a control signal for the force feedback system, the force feedback system including an force generating device rotatable connected to the second part of the rotational shaft; and, the processor transmitting the control signal to the force generating device, the control signal instructing the force generating device to exert a second torque to the second part of the shaft, the second torque being opposite to the first torque. Hence, the invention accurately determines the angle of twist of a rotatable shaft of an exercise apparatus where after the angle of twist is used to by a force feedback system to determine a control signal for an force generating device that generates a braking force exerted on the second part of the shaft that counters the force which an athlete exerts on a first part of the shaft.

The processor of the force feedback system may execute an algorithm representing a kinetic model of the exercise apparatus. Continuously measuring the angle of twist as a function of the force exerted onto (a part of) the exercise apparatus allows the algorithm to accurately model a predetermined exercise apparatus, e.g. an exercise bicycle or a rowing apparatus. This way, a user of the exercise apparatus will be provided with an improved user experience.

More generally, the present invention enables a force feedback system of an exercise apparatus to accurately compute the correct feedback force based on information of the position of a first and second part of a rotating shaft to which a torque is applied by a user of the exercise apparatus. The information may be used in an algorithm representing a kinetic model of the exercise apparatus. The algorithm may also use other information such as the exercise performed, the position of the human body and its specific measurements (tuned to the specific athlete), the equipment used in real life (for instance, type and size of the bike, along with seat height, etc.) to determine a feedback force.

The invention may be used for measuring torques for a rotational shaft of any equipment where varying loads are offered on both ends leading to large rotational (reversible) deformation in said shaft that need to be measured more times per rotation.

In an embodiment, the rotating shaft may include a deformable structure between the first part and second part of the shaft, the deformable structure having a predetermined spring constant. In an embodiment, the deformable structure may be a spring structure such as a torsion spring structure. In an embodiment, the deformable structure may provide a linear correlation between the angle of twist and the first and second torque applied to the shaft.

In an embodiment, the first position information may include a first periodic signal, wherein each period of the first periodic signal is associated with a position of the first part of the rotatable shaft relative to a reference position. In an embodiment, the second position information may include a second periodic signal, wherein each period of the second periodic signal may be associated with a position of a second part of the rotatable shaft relative to a reference position.

In an embodiment, the processor may determine the angle of twist as a function of time on the basis of the first and second periodic signal. In an embodiment, the first and second periodic signal may be a block wave signal or a pulse signal.

In an embodiment, the encoder system may include at least one detector. In an embodiment, the first periodic signal may be generated by the plurality of first position indicators sequentially passing the at least one detector and the second periodic signal may be generated by the plurality of second position indicators sequentially passing the at least one detector.

In an embodiment, the encoder system may include a first readout structure in contact with a first part of the rotatable shaft and a second readout structure in contact with a second part of the rotating shaft.

In an embodiment, the readout structure may comprise a plurality of first position indicators, wherein each first readout element may be associated with an (absolute) position of the first part of the rotatable shaft relative to a reference position and the second readout structure may comprise a plurality of second position indicators, wherein each second readout element may be associated with an (absolute) position of the second part of the rotatable shaft relative to a reference position.

In an embodiment, the first readout structure may further comprise a first reference readout element defining a first reference position of the first part of the shaft and the second readout structure may further comprising a second reference readout element defining a second reference position of the second part of the shaft.

In an embodiment, the first readout structure may include a first disc including the plurality of first position indicators along the periphery of the first disc, each readout element being associated with an absolute angular position of the first part of the shaft; and, the second readout structure includes a second disc including the plurality of second position indicators, preferably optical, electrical (e.g. capacitive) or magnetic position indicators, along the periphery of the second disc, each second readout element being associated with an absolute angular position of the second part of the shaft.

In an embodiment, the plurality of first and second position indicators may be optical position indicators, e.g. an array of slots or the like. These optical position indicators may be detected using an optical detector. In a further embodiment, the first and second position indicators may be magnetic position indicators. Such magnetic position indicators may be detected using a magnetic detector, e.g. a magnetic read-head or the like. In yet another embodiment, the first and second position indicators may be electric (e.g. capacitive) position indicators, which may be detected using a capacitive detector.

In an embodiment, the rotation velocity of the shaft may be between 30 and 600 rotations per minutes (between 0, 5 and 10 Hz). In an embodiment, the plurality of first and second position indicators of the first and second readout structure respectively may be arranged to provide between 180 and 540 readout counts per rotation of the shaft.

In an embodiment, the first torque may be associated with a user of the exercise apparatus exerting a force onto a force receiving structure of the exercise apparatus, the force receiving structure being rotatable connected to the first part of the rotatable shaft. In an embodiment, the force receiving structure may include a push mechanism and/or a pull mechanism.

In an embodiment, the encoder system may include at least one detector, the plurality of position indicators sequentially passing a detector, wherein—during the passing of a readout element—the position of a readout element may be measured multiple times by the detector.

In an embodiment, the force feedback system may use a kinematic model of the exercise apparatus to determine a value of the second torque.

In an embodiment, the exercise apparatus may be a stationary bike, e.g. spinning bike. In an embodiment, the rotatable shaft may be part of the back axis of the bike, wherein the first part of the rotatable shaft may be connected to a crank via e.g. a chain.

In an embodiment, the rotatable shaft may include a torsion spring structure in the shape of a mainspring, the main spring being contained in a (circular) enclosure, the main spring including an outer end connected to the outer enclosure, the outer enclosure being connected to the first part of the shaft and the main spring including an inner end connected to the second part of the shaft.

In an embodiment, the encoder system may be further configured to measure third position information for measuring the rotary position of the crank, preferably the processor using the third position information for determining if a user of the exercise apparatus is freeriding.

In an aspect, the invention may also relate to a computer-controlled exercise apparatus. In an embodiment, the exercise apparatus may comprise: a frame comprising a force receiving structure that is rotatable connected to a first part of a rotatable shaft of the exercise apparatus and a force generating device connected to the second part of the rotational shaft; an encoder system configured to measure first position information of the first part of a rotatable shaft and a second position information of the second part of the rotatable shaft, the signal being generated by the encoder system in response to a user of the exercise apparatus applying a force to the force receiving structure, the force exerting a first torque to the first part of the rotatable shaft; and, a force feedback system including an force generating device rotatable connected to the second part of the rotational shaft and a processor of a computer for controlling the force generating device, the processor being configured to: receive at least one signal from an encoder system, the at least one signal including the first position information and the second position information; use the first second position information and second position information in the at least one encoder signal to compute an angle of twist between the first part and second part of the shaft; and, using the angle of twist to compute a control signal for the force feedback system; and, transmit the control signal to the force generating device, the control signal instructing the force generating device to exert a second torque to the second part of the shaft, the second torque being opposite to the first torque.

In an embodiment, the rotating shaft may include a deformable structure, preferably a spring structure such as a torsion spring structure, between the first part and second part of the shaft, the deformable structure having a predetermined spring behaviour, preferably the deformable structure providing a linear correlation between the angle of twist and the first torque applied to the shaft.

In an embodiment, the first position information includes a first periodic signal, preferably a block wave signal or a pulse signal, wherein each period of the first periodic signal is associated with a position of the first part of the rotatable shaft relative to a reference position; and, wherein the second position information includes a second periodic signal, preferably a block wave signal or a pulse signal, wherein each period of the second periodic signal is associated with a position of a second part of the rotatable shaft relative to a reference position, preferably the processor determining the angle of twist as a function of time on the basis of the first and second periodic signal.

In an embodiment, the encoder system may include at least one detector, preferably a first and second detector, a plurality of first position indicators connected to the first part of the shaft and a plurality of second position indicators connected to the second part of the shaft, the first periodic signal being generated by the plurality of first position indicators sequentially passing the at least one detector and the second periodic signal being generated by the plurality of second position indicators sequentially passing the at least one detector.

In an embodiment, the encoder system may include a first readout structure in contact with a first part of the rotatable shaft and a second readout structure in contact with a second part of the rotating shaft, the first readout structure comprising a plurality of first position indicators, each first readout element being associated with an (absolute) position of the first part of the rotatable shaft relative to a reference position and the second readout structure comprising a plurality of second position indicators, each second readout element being associated with an (absolute) position of the second part of the rotatable shaft relative to a reference position.

In an embodiment, the first readout structure may further comprise a first reference readout element defining a first reference position of the first part of the shaft and the second readout structure further comprising a second reference readout element defining a second reference position of the second part of the shaft.

In an embodiment, the first readout structure may include a first disc including the plurality of first position indicators, preferably optical or magnetic position indicators, along the periphery of the first disc, each readout element being associated with an absolute angular position of the first part of the shaft; and, the second readout structure may include a second disc including the plurality of second position indicators, preferably optical or magnetic position indicators, along the periphery of the second disc, each second readout element being associated with an absolute angular position of the second part of the shaft.

In an embodiment, the rotation velocity of the shaft may be between 30 and 600 rotations per minutes (between 0, 5 and 10 Hz). In an embodiment, the plurality of first and second position indicators of the first and second readout structure respectively may be arranged to provide between 150 and 600 readout counts per rotation of the shaft.

In an embodiment, the first torque being associated with a user of the exercise apparatus exerting a force onto a force receiving structure of the exercise apparatus, preferably the force receiving structure including a push mechanism and/or a pull mechanism, the force receiving structure being rotatable connected to the first part of the rotatable shaft.

In an embodiment, the encoder system may comprise at least one detector, preferably a first and second detector, the plurality of position indicators sequentially passing a first or second detector, wherein—during the passing—the position of a readout element is measured multiple times by the detector.

In an embodiment the processor of the force feedback system may execute an algorithm representing a kinematic model of the exercise apparatus to determine a value of the second torque.

In an embodiment, the exercise apparatus may be a stationary bike, such as a spinning bike, the rotatable shaft being the back axis of the spinning bike and the first part of the rotatable shaft being connected to a crank, preferably the rotating shaft including a torsion spring structure, preferably the torsion spring structure having the shape of a mainspring, the main spring being contained in a (circular) enclosure, the main spring including an outer end connected to the outer enclosure, the outer enclosure being connected to the first part of the shaft and the main spring including an inner end connected to the second part of the shaft.

in an embodiment, the encoder may comprise an absolute zero trigger, which signals the controller that controls the force generating device that a predefined position is detected. In a further embodiment, a multichannel position encoder may be used to determine the position, preferably the angular position. In more general, any encoder system that is able to determine the position of a first part and a second part of a shaft may be used for determining an angle of twist.

In an embodiment, the rotatable shaft may include a deformable part, the deformable part having a predetermined spring constant, preferably the deformable part providing a linear correlation between the angle of twist and a torque applied to the shaft. In an embodiment, first encoder may include a first encoder structure connected to the first end and a second encoder structure connected to the second end, a first readout device generating the first encoder signal when the first encoder structure passes the first readout device and a second readout device generating the second encoder signal when the second encoder structure passes the second readout device.

In known exercise apparatus it is common to measure the rotational/translational speed of a resistance unit with a single encoder. In contrast, the current invention a second encoder is added on a different moving part of the apparatus to obtain more information about the type of motion and the phase of the motion. An example is a bicycle where the motion and position of both the crank as the resistance motor are measured to determine and accurately counterbalance freewheeling. Another is that of a cross-country skiing apparatus that measures not only the overall speed of the apparatus, but also the speed and position of each individual leg as it is positioned on the gliding unit.

In one aspect, this disclosure relates to a torque sensing system that comprises a rotatable shaft having a first rotatable part and a second rotationally fixed part, the shaft comprising a spring structure between the first and second part. This system comprises a first readout structure connected to the first part, the first readout structure comprising first position indicators. This system comprises a detector system for detecting the first position indicators and generating a first detection signal indicating respective passing times for the first position indicators. This system comprises a processor being configured for: (i) determining an angular position of the first readout structure occurring at a particular time instance based on a detected passing time of at least one first position indicator on the first readout structure and on a first relation between angular position of the first readout structure and time around said particular time instance; (ii) determining an angle of twist at the particular time instance based on the angular position of the first readout structure, the angle of twist being associated with a torque applied to the first and/or second part of the rotatable shaft.

In one aspect, this disclosure relates to a torque sensing system comprising a computer that is configured to perform steps of (i) determining the rotary position of the first disc for a particular time instance, t_i and (ii) determining the rotary position of the second disc for said particular time instance. Step (i) comprises receiving a signal comprising a first transition associated with a first time instance, the first transition being associated with a first edge of a position indicator on the first disc, the first edge having a first position on the first disc relative to the reference indicator on the first disc and the signal comprising a second transition associated with a second time instance, the second transition being associated with a second edge of a position indicator on the first disc, for example of the same position indicator or of an adjacent position indicator, the second edge having a second position on the first disc relative to the reference indicator on the first disc. Step (i) further comprises, based on the first time instance and on the second time instance and optionally based on a distance, such as an angular distance, between the first and second edge, determining a velocity, such as an angular velocity. Step (i) further comprises based on the determined velocity and said second position, determining the rotary position of the first disc for said particular time instance, preferably the particular time instance occurring after the first time instance and after the second time instance. Step (ii) comprises receiving a signal comprising a third transition associated with a third time instance, the third transition being associated with a third edge of a position indicator on the second disc, the third edge having a third position on the second disc relative to the reference indicator on the second disc and the signal comprising a fourth transition associated with a fourth time instance, the fourth transition being associated with a fourth edge of a position indicator on the second disc, for example of the same position indicator or of an adjacent position indicator, the fourth edge having a fourth position on the second disc relative to the reference indicator on the second disc. Step (ii) further comprises, based on the third time instance and on the fourth time instance and optionally based on a distance, such as an angular distance, between the third and fourth edge, determining a velocity, such as an angular velocity. Step (ii) further comprises based on the determined velocity and said fourth position, determining the rotary position of the second disc for said particular time instance, preferably the particular time instance occurring after the third time instance and after the fourth time instance. The computer is further configured to perform a step of, based on the determined rotary position of the first disc and on the determined rotary position of the second disc, preferably on a difference between these rotary positions, determining the torsional angle for said particular time instance.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1A-1F depict a torque sensing system and a computer-controlled force feedback system using such torque sensing system according to various embodiments of the invention.

FIGS. 2A and 2B depicts a read-out scheme of a torque sensing system according to an embodiment of the invention.

FIG. 3 depicts a flow diagram of a process for controlling a force feedback system according to an embodiment of the invention.

FIG. 4 depicts a schematic of a spinning bike comprising a computer-controlled force feedback system according to an embodiment of the invention.

FIG. 5 depicts a schematic of a part of an encoder system according to an embodiment of the invention.

FIG. 6 depicts a computer-controlled force feedback system according to another embodiment of the invention.

FIG. 7 depicts a computer-controlled force feedback system according to yet another embodiment of the invention.

FIG. 8A-8B depicts a spring structure for a rotatable shaft according to an embodiment of the invention.

FIG. 9 is a block diagram illustrating an exemplary data computing system that may be used for executing methods and software products described in this disclosure.

### DETAILED DESCRIPTION

The embodiments described in this application are aimed at torque sensor systems that are capable of providing a high signal to noise ratio and high frequency feedback at across a wide range of rotation speeds, e.g. 10 and 500 rotations per minutes. The torque sensor systems are especially suitable for use in a force feedback system, such as an exercise apparatus configured to provide a real-life exercise experience, e.g. an outdoor biking experience or an outdoor rowing experience. The invention aims to provide an accurate measure of a force that is applied to a rotatable shaft comprising a first and second part and a spring structure for mechanically connecting the first of the shaft with the second part of the shaft. An encoder system is configured to measure an angle of twist between the first and second part when a first and second torque is applied to the first and second part respectively. A first readout structure, connected to a first part of the shaft may comprise first position indicators, and a second readout structure connected to the second part of the shaft may comprise second position indicators, wherein the first and second position indicators may be used to determine an absolute rotary position of the first and second part of the rotatable shaft respectively.

For example, when the shaft rotates due to the application of the torques, a reference indicator and position indicators arranged on the readout structure may pass a stationary detector of an encoder system thereby generating a reference signal associated with the reference indicator and a periodic signal, e.g. a square wave type signal, associated with the position indicators. Here, each period of the periodic signal may relate to the detection of a position indicator passing the detector. The position of each position indicator relative to the reference indicator is accurately known. Thus, the reference signal may trigger the encoder system to start counting and determining the passing of subsequent position indicators in time, based on a known or estimated rotation direction. This way, the absolute rotary position of the first and second part of the shaft can be determined as a function of time. After one rotation, a next reference signal may be detected and the encoder may restart the counting process for the next rotation. Thus, during the rotation of the shaft, at each time instance, the position of the first part of the shaft and the position of the second part of the shaft may be determined. Instead of an absolute rotary encoder based on a readout structure comprising (at least one) reference indicator and a plurality of position indictors, an absolute rotary encoder based on coded position indicators may be used. At a time instance, a position indicator in the form of a coded pattern may be read out by a detector, wherein the coded pattern may be directly translated to a position.

This way, the absolute (rotary) position of the first and second part of the shaft may be measured independently and used to determine the angle of twist caused by the torques applied to both parts of the shaft. Measuring the positions of the position indicators and the reference indicators at the first and second part of the shaft may provide an accurate measure of the angle of twist as a function of time. This signal may be processed by a processor in order to determine a control signal for an electrometer that connected to the second part of the shaft. Embodiments and non-limiting implementations of the invention are described hereunder with reference to the figures.

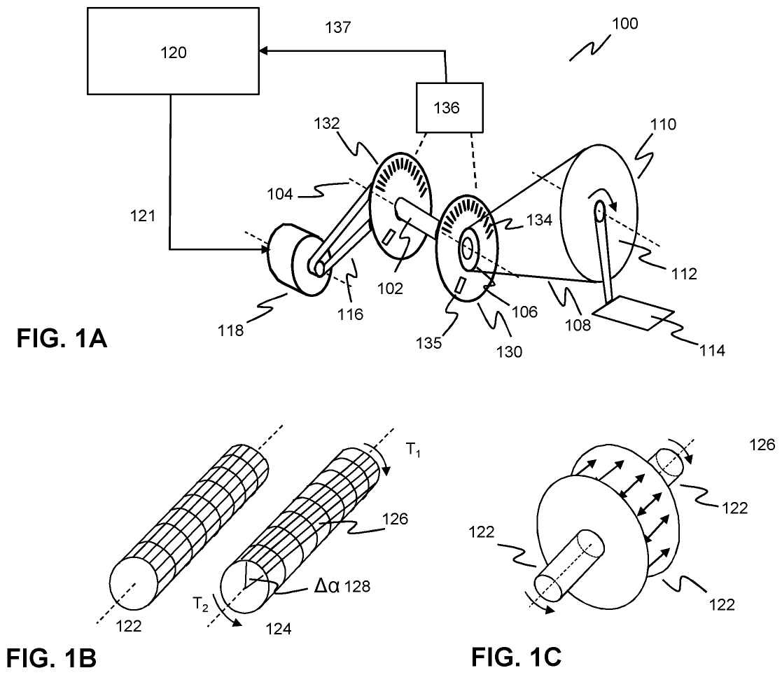

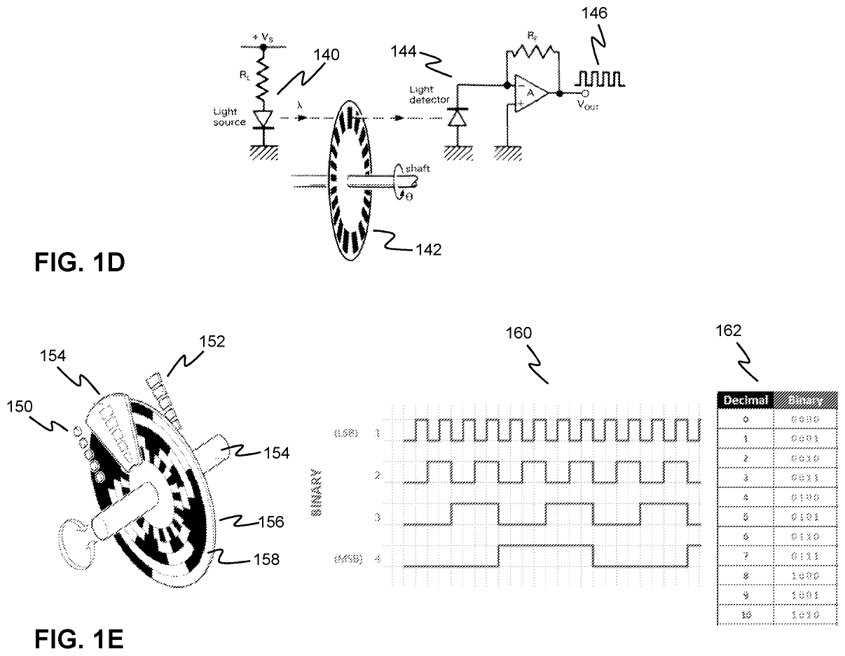

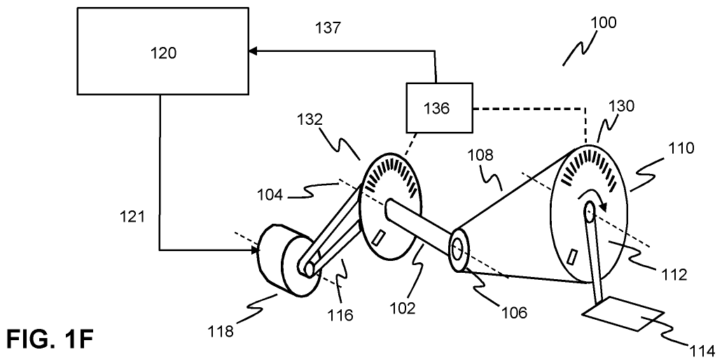

FIG. 1A-1F depict a torque sensing system and a computer-controlled force feedback system using such torque sensing system according to various embodiments of the invention. FIG. 1A depicts a torque sensing system comprising rotatable shaft 102 wherein the shaft comprises two parts to which opposing torques can be applied. The resulting torque applied to the shaft may cause the shaft to rotate around its longitudinal axis 104. The shaft may be part of a mechanical or electro-mechanical apparatus. For example, in an embodiment, the shaft may be part of an exercise apparatus 100, e.g. a stationary exercise bicycle or a rowing apparatus. In an embodiment, the shaft may be part of an axis, e.g. a rear axis, of a spinning bike, wherein the shaft may be rotatable mounted in a stationary frame (not shown) of the exercise apparatus such that the shaft can rotate around its longitudinal axis.

The shaft of the torque sensing system may include a first part (e.g. a first end) configured to receive a first torque and second part (e.g. a second end) configured to receive a second torque. To that end, the first part may be connected to a force receiving structure, i.e. structure for receiving an external force. For example, in case of a stationary exercise bicycle, a rear gear 106 may be connected to the first part of the shaft so that the shaft is rotatable connected via a chain or a band 108 to a (chain)wheel 110 that is mounted to a rotatable crank 112. The crank may include crankarms to which pedals 114 are attached. When exerting a force to the force receiving structure, e.g. the pedals, a first torque may be applied to the shaft which may cause the shaft to rotate. The second part of the shaft may be configured to receive a braking force of a force generating device 118 or mechanism. Such force generation device may include any type of means for generating a force, including but not limited to a braking force mechanism based on a mechanical brake, an eddy current brake, a viscous brake, an alternator brake, etc. In an embodiment, the force generation device may be controlled by a computer 120 in order to controllably apply a torque of a predetermined value to the second part of the shaft.

For example, in FIG. 1A a force generating device in the form of an alternator may be rotatable connected via e.g. driving band 116 to the second part of the shaft. The force generating device may be controlled by the computer 120 to exert a resistance force or brake force on the second part, which may create a second torque which is opposite to the first torque created by e.g. an external force such as pedal forces. The shaft may include an elastically deformable part (not shown), e.g. a spring structure, that has a predetermined spring behaviour. In particular, part of the shaft may include an elastic spring part that exhibits a reversible torsional elastic deformation that is approximately linear with the torque that is applied to the shaft. The spring structure may be implemented in various ways. For example, the spring structure may include an elastomeric material or a mechanical spring, etc. enabling relative rotary displacement of the two parts of the shaft when a torque is exerted on the shaft.

An example of a reversible deformation of a spring structure is schematically shown in FIG. 1B, wherein spring structure 122 represents a spring structure in the form of a shaft which flexible in the rotary direction. In this case no torque is applied, Spring structure 124 depicts the same spring structure in the situation when a torque is applied to both ends. In that case, the structure may exhibit a reversible torsional deformation 126 resulting in a relative rotational displacement Δα between the two ends of the spring structure, wherein the relative rotational displacement is referred to as the so-called angle of twist Δα 128. The angle of twist represents a measure of the torque applied to the spring structure, and thus to the shaft of the torque sensing system.

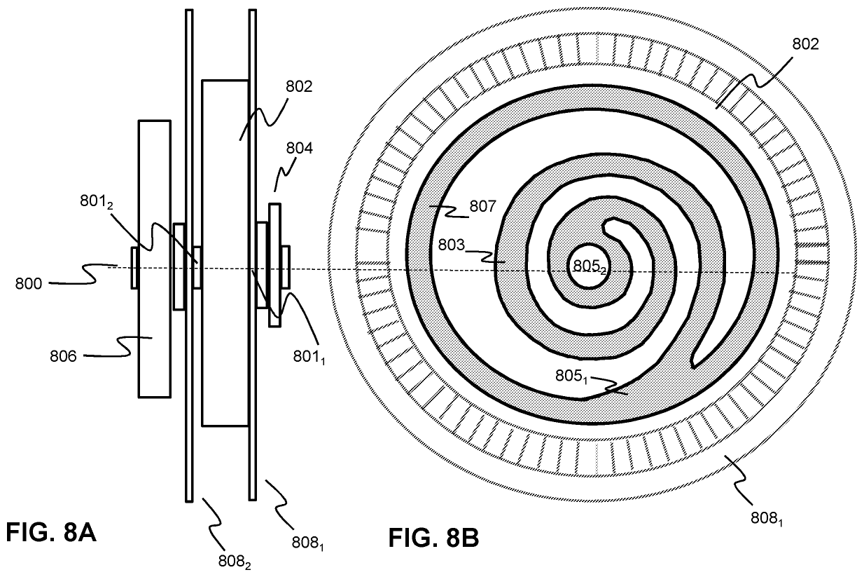

The spring structure 122 may have any suitable form as long as it is capable of providing linear correlation between the torques applied to the shaft and the angle of twist. This is schematically depicted in FIG. 1C, wherein a rotary shaft 123_{1,2} includes a first part 123₁ and a second part 123₂, wherein the first part of the shaft is coupled to the second part of the shaft via a coupling structure 125 for coupling the first shaft to the second shaft may exhibit spring like behaviour in the rotary direction. The coupling structure can have any suitable form and may comprise one or more mechanical rotary springs, compression springs and/or one or more (visco)elastic springs. A detailed embodiment of a spring structure will be discussed hereunder with reference to FIG. 8.

In case of an exercise apparatus, such a stationary exercise bicycle, when an athlete starts pedalling, the applied torque will depend on the angular position of the crank and typically exhibits a periodic variation that coincides with one full rotation of the crank. The variation however in one crank rotation may vary greatly depending on a lot of different parameters, including e.g. the position of the crank, the position of the athlete, the muscular build of the athlete. etc. In order to provide an outdoor cycling experience on a spinning bike, the computer need to be able to measure the applied force and fast force variations applied to the shaft (and thus the angle of twist Δα) at very high sampling rates and relatively low rotation speeds for example sample rates>100 Hz at approx. 10 rpm, so that the angle of twist accurately follows the applied force during pedalling as a function of time.

To that end, a first readout structure 130 may be connected to the first side of the shaft and a second readout structure 132 may be connected to the second side of the shaft. The first and second readout structures may be part of an encoder system 136 for determining first position information associated with an (absolute) rotary position of a plurality of first position indicators, e.g. slots, of the first readout structure and for determining second position information associated with the position of a plurality of second position indicators of the second readout structure. The position indicators may be detected using a readout device, which has a detection zone in which the readout device is able to detect a position indicator. This way, each time a position indicator passages the detection zone of the readout device, the readout device may generate readout signals. In an embodiment, the encoder system may be configured as a rotary encoder system. In embodiment, the encoder system may include readout structures in the form a disc connected to the shaft that is provided with position indictors 134 and a reference indicator 135. Each of the position indicators may have predetermined dimensions and/or shapes. The position indicators may be provided along a circular path on the disc, e.g. a circular path at the periphery of the disc.

When in use, the position indicators will pass the detection zone of the readout device. The time at which a position indicator passes the detection zone is hereafter referred to as the passing time. The signal produced by the readout device may depend on the position of the position indicator within the detection zone. For example, the signal may exhibit a high amplitude signal when the position indicator is exactly inside the detection zone of the readout device and the signal may exhibit a lower signal amplitude when the position indicator enters or leaves the detection zone. The readout signal of the readout device may be determined one or more times during the passage of the position indictor through the detection zone. For example, depending on the implementation, a position indicator entering the detection zone may generate the signal going high value to a low value or vice versa. Each measured readout signal may be time stamped using e.g. a clock which may be part of the encoder system. This way, a sequence of time-stamped readout signals may be determined during the passage of a position indicator moving through the detection zone of the readout device. The position information generated by the encoder system may include such sequences of time-stamped read-out signals which may be used to determine, the rotary positions of the first and second side of the shaft at every time instance.

The information obtained from the time-stamp maybe used to generate position information at much higher frequencies than the frequencies of the readout signals by using an interpolation or extrapolation algorithm for interpolating or extrapolating the data that has been measured.

The encoder system may be implemented in different ways, e.g. in an embodiment, the encoder system may include one or more optical encoders, wherein the readout structure may include a plurality of position indicators in the form of one or more slots, e.g. windows. A readout device may include an optical source and at least one optoelectronic detector for determining the passage of an (optical) position indicator. In another embodiment, the encoders may be magnetic encoders, wherein the readout structure may include a plurality of position indicators in the form of magnetic elements. Further, the readout device may include at least one magnetic head for detecting the passage of a (magnetic) position indicator.

In an embodiment, the readout structure may include a reference element, e.g. a window or a magnetic element, that has dimensions or physical properties (e.g. magnetic field strength) that are different from the regular position indicators.

In a further embodiment the readout device may comprise one or more camera's. In that case, one or more position indicators may be associated with a code, e.g. a barcode or a QR code representing a unique (sequence) number, which may be used to link a position indicator to a position. For example, in an embodiment, the position indicators may be configured as coded slots which may be read out optically or magnetically. The position indicators are coded such that each position indicator can be associated with a different code which in turn may be related to an absolute rotary position, using e.g. a lookup table or a mathematical function.

The coding one or more position indicators enable the computer to determine a rotary position for each position indicator of the readout structure. Coding can be based on one indicator (e.g. a reference indicator) indicating the absolute position of one position indicator which may be used to derive the absolute positions of the other position indicators. Alternatively, a plurality of position indicators may be coded so that each of the position indicators can be directly linked to a position.

An optical system may be used to enable the camera to monitor one or more encoders. For example, an optical system may be configured to arrange both encoders in the in the field of view a digital camera, so that the position indicators of both readout structures can be readout simultaneously by the digital camera.

Examples of encoder readout systems are depicted in FIGS. 1D and 1E. As shown in FIG. 1D, the readout may include a light source 140, e.g. a laser diode, which emits light towards the readout structure, in this example position indictors in the form of slots or windows in rotatable encoder disc 142, which is connected to a rotatable shaft. An optical structure, e.g. refractive elements or the like (not shown) may be used to focus the light as a light beam onto the slots. During rotation (when the light source is positioned in line with the slots in the encoder disc) the light beam of the light source will pass through the encoder disc if a window or part of a window is positioned between the light source and a readout device. In that case light will be detected by a light detector 144 so that a readout signal 146 is generated. The light beam will be blocked if no window is positioned between the light source and the readout device. Hence, when the encoder disc rotates, the light detector (the readout device) will be periodically exposed by a light signal. This way, a signal is generated by the light detector in the form of a periodic signal, e.g. a block wave, sinusoidal or a pulse-like signal, wherein the frequency of the signal may depend on the number of position indicators (the number of slots) and the rotational speed of the shaft. The signal may be sampled in time thus generating multiple time-stamped samples for each position indicator (window or slot) passing the readout device (the light detector). As will be described hereunder in more detail, an additional reference indicator associated with an absolute rotary position of the shaft may be used to relate each of the position indicators on the disc to an absolute position. Further, the encoder scheme depicted in FIG. 1D may be easily extended to a so-called quadrature encoder in which two detectors positioned relative to each other so that the second detector detects a second periodic signal that is 90 degrees phase shifted. This known encoder scheme may be used to determine also the rotation direction.

Thus, a detector (a readout device) of the torque sensing system depicted in FIG. 1A may generate a detector signal when position indicators pass a detection zone the detector. In an embodiment, at least one of the position indicators may be configured as a reference indicator which is configured to provide a different response than the other position indicators. In that case, the signal generated by the readout device may include a reference signal which can be used as a reference for determining the position of the other position indicators. Thus, when the reference signal is detected by the computer, it knows the absolute rotary position of the encoder disc. Then, each subsequent detector signal that signals the passing of a position indicator can be counted by a counter. The number of detected position indicators relative to the reference signal may be used to determine an absolute position of a side of the shaft. Such encoder system is also referred to as an incremental rotary encoder. In another embodiment, the reference indicator may be implemented separately from the position indicators. For example, a separate detector may detect the reference indicator and generate a separate reference signal for signalling the detection of a reference indicator passing the detector.

FIG. 1E depicts a so-called absolute encoder readout system including a rotatable shaft 154 connected to an encoder disc 156 which can be optically read. Different circular slot patterns may be arranged around the shaft, wherein each circular slot pattern can be readout by an optical sensor, each optical sensor including a light source 150 and a light detector 152. An optical stop 154 and optical elements such as refractive elements (not shown) may be used to position a light beam on one of the circular slot patterns. The circular slot patterns are arranged such that the output signals 156 of the optical sensors may form a digital representation for a position. For example, the four circular slot patterns in FIG. 1E may generate four periodic block functions of different period so that the signal amplitudes at a particular time instance directly translates into a binary value. The resolution of the encoder is determined by the bit resolution (e.g. 8 bits would give 256 positions). Further, by measuring two or more position indicators also the rotary direction can be determined.

FIG. 1F depicts a torque sensing system which is similar to the system depicted in FIG. 1A with the exception that the first readout structure 130 may be part of the crank. This way, the first readout structure is rotatable connected to the first part of the rotatable shaft via a chain or a band 108 connecting the chain wheel of the crank with a rear gear connected to the first part of the shaft. More generally, the first and/or second readout structures may be directly connected to the shaft or indirectly via a gearing system or any other suitable transmission system. Furthermore, the position indicators described with reference to the embodiments in this application may be realized in any suitable form as long as there is a direct relation between the position of the rotatable shaft and the position of position indicators that are monitored by a detector. For example, instead of slots or markers on a disc connected to a part of the shaft, chain links of a chain connecting the crank with the read gear may be used as position indicators

Typical values e.g. the rotation velocity of the shaft may be between 10 and 500 rotations per minutes. Further, the plurality of first and second position indicators of the first and second readout structure respectively may be arranged to provide between 150 and 600 readout counts per rotation of the shaft. This way, the position may be determined very accurately, even at low rotation frequencies.

The encoder system may sample the detector signal a large number of times. For example, sample frequencies higher than 100 Hz at relatively low rotation speeds (10 rpm) can be achieved. Such high sample frequencies are necessary to accurately determine the angle of twist Δα and fast variations in the angle of twist in the shaft due to changes in forces applied by the user to a part, e.g. the pedals, of the exercise device.

When the exercise apparatus is in use, the encoder system 136 may generate at least one (encoder) signal 137 that includes first and second position information associated with the first and second readout structure respectively. The position information may have form of one or more periodic signals, e.g. one or more block wave signals, sinusoidal signals or pulse signals. In an embodiment, during readout, the passage of a reference indicator (e.g. a reference window of the readout structure) may be detected generating a reference signal. The reference signal may be used to identify each subsequent position indicator that passes the detector. After each full rotation of the shaft, a new reference signal may be generated. The reference signal may be coded into the encoder signal that is sent to the computer. The reference signal may trigger the computer to start counting the number of (block wave) periods in the encoder signal, wherein each period is associated with a position indicator passing the detector. When a torque is applied to both ends of the shaft, the shaft will start to rotate, and, in response, the encoder system may start generating first and second position information associated with both readout structures. The computer 120 may determine the angle of twist Δα caused by the torque based on the rotary position of the first and second part of the shaft as determined by the encoder system. In particular, the angle of twist may be the difference between the first rotary position and the second rotary position at a certain time instance.

In an embodiment, the angle of twist may be used in an algorithm representing a kinematic model of the exercise apparatus. A known kinematic model is described in U.S. Pat. No. 7,833,135. Based on the model, the computer may determine a control signal or a feedback 121 for the force generating device 118 which may generate a brake force that partly counters the force that is applied by the user. In case of an exercise apparatus, the brake force may be experienced by a user of the exercise apparatus as a resistance. The resistance force may be controlled at a time scale that includes variations in the torque due to variations in the force applied to the exercise apparatus by the user.

The resulting torque that is applied to the shaft at each time instance may introduce a reversible torsional deformation in the spring structure of the shaft. The reversible torsional deformation may cause a relative rotational shift between the position indicators of the readout structures connected to the first and second part of the shaft. Because the encoder system is able to measure an absolute rotary position for the first and second part of the shaft, the relative shift between the position indicators may be larger than the rotational angle between two subsequent position indicators of the first readout structure or the second readout structure. In particular, the spring structure may be configured to provide a maximum angle of twist which is larger than the rotary angle between two subsequent position indicators of the first and second readout structure.

A reference indicator or coded position indicators may allow the computer to determine an absolute position of a position indicator that passes the detector. Thus, the spring behaviour of the spring structure, e.g. the spring constant, may be configured to provide a relative shift in the rotary position between the first and second readout structure between −20 and 20 degrees, preferably −10 and 10 degrees, in response to the application of an external force (or external forces) on the shaft. This way, a large signal to noise ratio can be obtained.

The computer may determine the angle of twist Δα for many time instances during the passing of the position indicators (e.g. a window or a magnetic element) by determining for each time instance a difference between an absolute rotary position of the first encoder disc and an absolute rotary position of the second encoder disc.

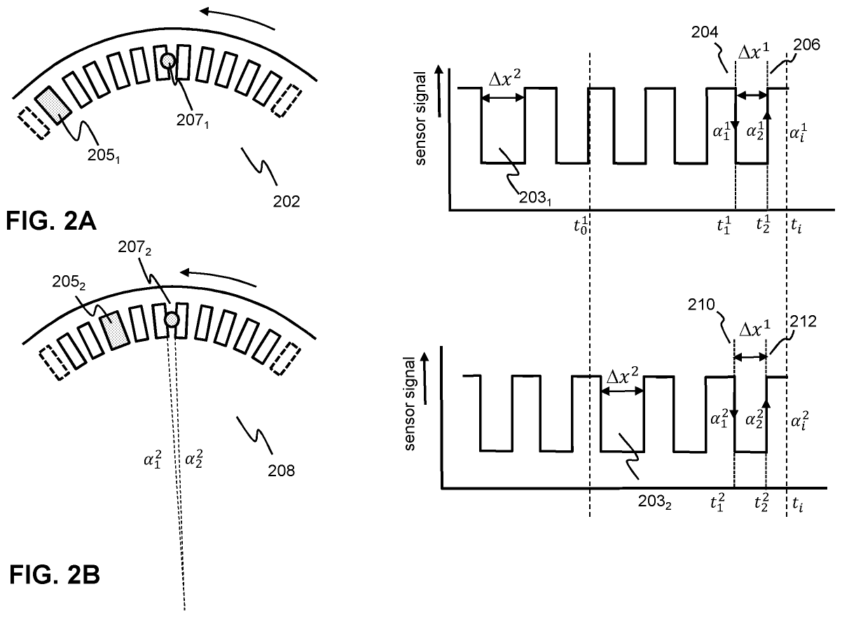

FIGS. 2A and 2B depicts a read-out scheme of a torque sensing system according to an embodiment of the invention. As described with reference to FIG. 1, the angle of twist Δα can be calculated by the computer by determining the rotary position of the first part of the shaft on the basis of the first position information in the encoder signal and the rotary position of the second part of the shaft on the basis of the second position information in the encoder signal. In an embodiment, in order to accurately determine the rotary positions of both encoder discs at each point in time, the readout of the encoder may be synchronized. Thus, the computer continuously reads out both encoder signals at high frequencies, i.e. 100 Hz or higher, and determines rotary positions of both rotary discs. Based on the rotary positions the computer may determine the angle of twist as a function of time wherein the angle of twist may be larger than the angle between two subsequent position indicators.

FIG. 2A depicts part of an encoder signal of the first encoder readout structure 202 connected to a first part of a rotating shaft. The encoder signal is for example output by the detector system that is configured to detect the first and second position indicators. The encoder signal includes a first signal 203₁ representing a reference signal and a second signal including a period block wave signal. The reference signal is generated by a reference indicator 205₁ of passing the detector 207₁. The periodic block wave signal may include a first transition 204 from a high sensor signal to a low sensor signal (going from a part where the optical signal is passed and detected to a part wherein the optical signal is blocked and not detected) and a second transition 206 going from a low signal (optical signal blocked) to a high signal (optical signal passed).

Similarly, FIG. 2B depicts part of an encoder signal of the second encoder readout structure 202 connected to a second part of the rotating shaft. The encoder signal includes a first signal 203₂ representing a reference signal and a second signal including a period block wave signal. The reference signal is generated by a reference indicator 205₂ of passing the detector 207₂. The periodic block wave signal may include a first transition 210 from a high sensor signal to a low sensor signal (going from a part where the optical signal is passed and detected to a part wherein the optical signal is block and not detected) and a second transition 212 going from a low signal (optical signal blocked) to a high signal (optical signal passed).

The angular positions of the transitional regions of the encoder disc are known very accurately. Moreover, the transitions in the encoder signal can be detected very precisely by the computer. Thus, as shown in FIGS. 2A and 2B, each transition in the encoder signal can be accurately linked to a left or right edge of a window in the encoder disc. The angular positions (e.g. α½ and α½ in FIG. 2A) of the edges can be very accurately determined as well as the distance Δx between edges. For example, the computer may determine that at a first time instance the first encoder detects the forth position indicator (i.e. four block wave periods relative to the first reference signal) while the second encoder detects the second position indicator (i.e. two block wave periods relative to the second reference signal). This information allows the computer to accurately determine a torsional angle Δα at an arbitrary time instance tᵢ.

FIG. 2A depicts a first detection signal indicating respective passing times for the first position indicators. The signal identifies a passing time t₁¹ of one of the first position indicators which may be for example of an edge of a window of a readout structure, which passes the detection zone of a detector. The signal may further identify a further passing time t₂¹ of another first position indicator passing the detection zone of the detector. Similarly, FIG. 2B depicts a second detection signal indicating respective passing times t₁² and t₂² for the second position indicators. FIGS. 2A and 2B also show that the passing times of the first and second position indicators do not coincide. For example, t₀¹, a passing time of a first position indicator of the first readout structure, does not coincide with a passing time of a second position indicator of the second readout structure. These detection signals may be used to determine angular positions of the first and second readout structures for an arbitrary time instance (for example tᵢ in FIGS. 2A and 2B). For first readout structure, the determination of an angular position at tᵢ may be based on a detected passing time t₂¹ and a relation between angular position of the first readout structure and time around said time instance tᵢ as explained below. Similarly, for the second readout structure, the determination of an angular position at tᵢ may be based on a detected passing time t₂¹ and a relation between angular position of the second readout structure and time around said time instance tᵢ as explained below.

In particular, FIG. 2A depicts a first encoder signal depicting a first transition 204 at time instance t₁¹ associated with angular position α₁¹ and a second transition 206 at time instance t₂¹ associated with angular position α₂¹, wherein the distance between the first and second transition is denoted as Δx¹. Based on this information, the angular position of the encoder disc at tᵢ can be predicted by the following equation: αᵢ¹(tᵢ)=α₂¹(t₂¹)+v¹(tᵢ−t₂¹) wherein v¹=Δx¹/(t₁¹−t₂¹). Herein, v¹ may be understood to define said relation between angular position of the first readout structure and time around time instance tᵢ. In this example, this relation is determined based on two detected passing times. However, three or more detected passing times may also be used to determine this relation, for example by using a polynomial fit procedure. Similarly, FIG. 2B depicts a second encoder signal depicting a first transition 210 at time instance t₁² associated with angular position α₁² and a second transition 212 at time instance t₂² associated with angular position α₂², wherein the distance between the first and second transition is denoted as Δx². Based on this information, the angular position of the second encoder disc at tᵢ can be predicted by the following equation: αᵢ²(tᵢ)=α₂²(t₂²)+v²(tᵢ−t₂²) wherein v²=Δx²/(t₁²−t₂²). Herein, v² may be understood to define said relation between angular position of the first readout structure and time around time instance tᵢ. This way, the torsional angle can be determined: Δα(tᵢ)=αᵢ²(tᵢ)−αᵢ¹(tᵢ)+αₒ at any time instance tᵢ. As the encoder system can determine absolute rotary positions, the scheme works for both small and large torsional angles at high accuracy. Here, the diameter of the encoder disc and the number of position indicators, e.g. slots or (coded) markers, on the encoder discs may determine the resolution of the readout. The more position indicators, the higher the resolution of the rotary position.

Thus, as shown from the FIGS. 2A and 2B, the processor of a torque detection system may be configured to determine an angular position of the first readout structure occurring at a particular time instance based on a detected passing time of at least one first position indicator on the first readout structure and on a first relation between angular position of the first readout structure and time around said particular time instance and to determine an angular position of the second readout structure occurring at the particular time instance based on a detected passing time of at least one second position indicator on the second readout structure and, optionally, based on a second relation between angular position of the second readout structure and time around said particular time instance. Based on these angular positions, the process may then determine an angle of twist at the particular time instance wherein, the angle of twist is associated with a torque applied to the first and/or second part of the rotatable shaft. This way, the processor is able to produce torque values on the basis of the detection signals at a high frequency rate that is needed by the feedback controller in order to provide stable real-time responses, which is needed for simulating a realistic user experience on an exercise apparatus.

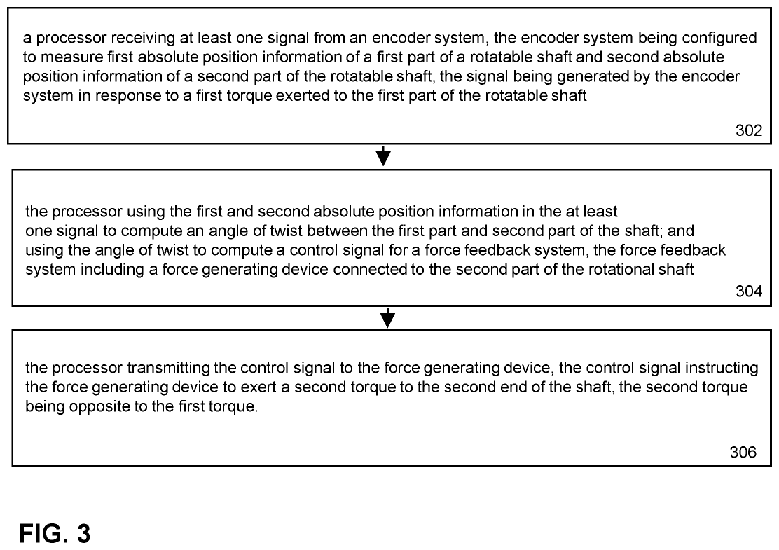

FIG. 3 depicts a flow diagram of a process for controlling a force feedback system according to an embodiment of the invention. As described with reference to FIGS. 1 and 2, the force feedback system may include a computer receiving information from the encoder system connected to an exercise apparatus and transmitting control information to a force generating device connected to the exercise apparatus. A processor of the computer may execute a program which includes a first step 302 wherein the computer receives at least one signal from an encoder system, wherein the encoder system is configured to measure first absolute position information of a first part of a rotatable shaft and second absolute position information of a second part of the rotatable shaft, the signal being generated by the encoder system in response to a first torque exerted to the first part of the rotatable shaft. Here, first and second absolute position information may be generated by the encoder system by reading out a first readout structure in contact with a first part of a rotating shaft and the second encoder signal may be generated reading out a second readout structure in contact with a second part of a rotating shaft of the exercise apparatus. The first torque be applied to the first part, may be associated with a user of the exercise apparatus exerting a force onto a part of the exercise apparatus, e.g. a crank, wherein the part of the exercise apparatus may be rotatable connected, e.g. via a chain, a band or any other suitable transmission system, to the first part of the shaft.

Then, in a second step 304, the computer may use the first and second absolute position information to compute an angle of twist between the first part and second part of the shaft; and use the angle of twist to compute a control signal for a force feedback system, the force feedback system including a force generating device connected to the second part of the rotational shaft. The computer may use the angle of twist as an input to a kinetic model of the exercise apparatus in order to determine a suitable brake force that needs to be applied to the second part of the shaft.

Thereafter, in a third step 306 the computer may transmit the control signal to the force generating device, wherein the control signal may control the force generating device to exert a second torque to the second end of the shaft, wherein the second torque may be opposite to the first torque.

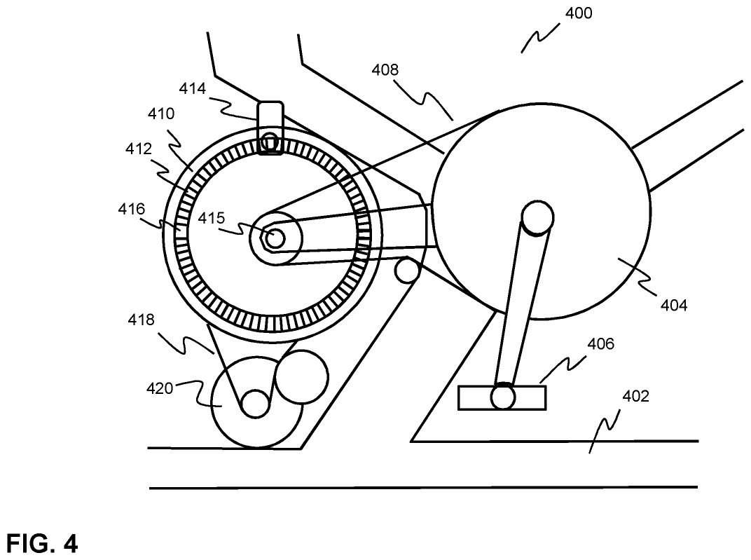

FIG. 4 depicts a schematic of a part of a spinning bike comprising a computer-controlled force feedback system according to an embodiment of the invention. In particular, this figure depicts the side face of part of an exercise apparatus 400, in this case a stationary bike, comprising a frame 402 supporting a force receiving structure, i.e. the force receiving structure in the form of a force crank 404 with pedals 406, wherein the crank is rotatable connected via a chain 408 to a back gear 415. Here, the back gear is connected to a first part (e.g. a first end) to a rotatable shaft. The first part of the shaft is further connected to a first encoder disc 410 comprising position indicators 412, e.g. slots, that are arranged along the periphery of the first encoder disc. A detector 414 is located at the position of the position indicators so that when the apparatus is in use, the first encoder disc will rotate in reaction to a force exerted on the first part of the shaft and the position indicators sequentially pass the detector, which detects the passing slots. This way, the detector may generate a periodic square wave type signal as described with reference to FIGS. 1 and 2 representing the rotary position of the first encoder disc as a function of time. The position indicators may include a reference readout element 416 which provides a reference signal. The reference signal may be used by the computer to detect the start of a new rotation and provides a reference position relative to the positions of position indicators. A force generating device 420 is rotatable connected via a band or a chain 408 to a second part of the shaft, wherein the second part of the shaft is connected to a second rotary disc, which can be readout by a second detector (not shown).

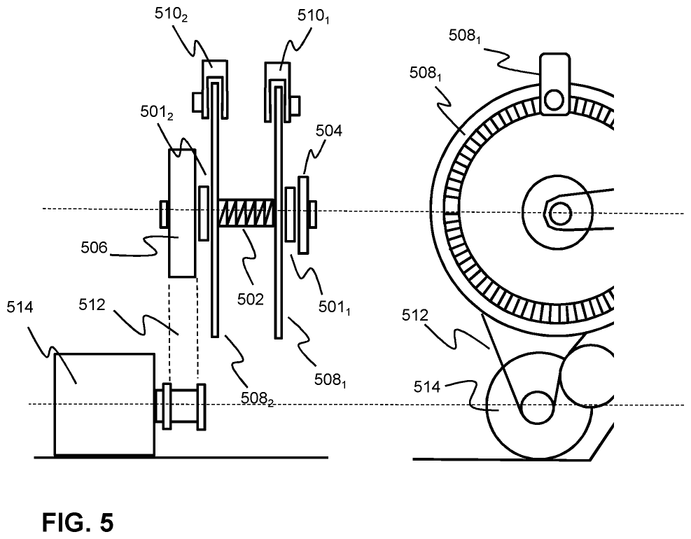

FIG. 5 depicts a schematic of another side view of the spinning bike as described with reference to FIG. 4. This figure illustrates the arrangement of the rotatable shaft 502 comprising a first part 501₁ and a second part 501₂. The shaft may comprise a deformable spring structure between the first and second part. Further, the shaft is rotatable mounted to the frame of the stationary bike and includes a gear unit 504 at a first end of the shaft and a driving wheel 506 at the second end of the shaft. A first encoder disc 508₁ including a plurality of first position indicators is connected to the first part of the shaft and a second encoder disc 508₂ comprising a plurality of second position indicators is connected to the second part of the shaft. When a force is exerted on the first part of the shaft, the shaft starts to rotate and the first and second encoder discs are read out by a first detector 510₁ and second detector 510₂ respectively, wherein a periodic signal generated by the first detector represents location information of the first part of the shaft and the periodic signal generated by the second detector represents location information of the second part of the shaft. Here, the driving wheel may be rotatable connected via a driving belt 512 to a driving wheel of a computer-controlled electronic motor 514, which is configured to produce a brake force which will be applied as a second torque to the second part of the shaft. The shaft encoder arrangement provides a compact design which can be easily integrated in conventional exercise apparatuses, such as an exercise bicycle.

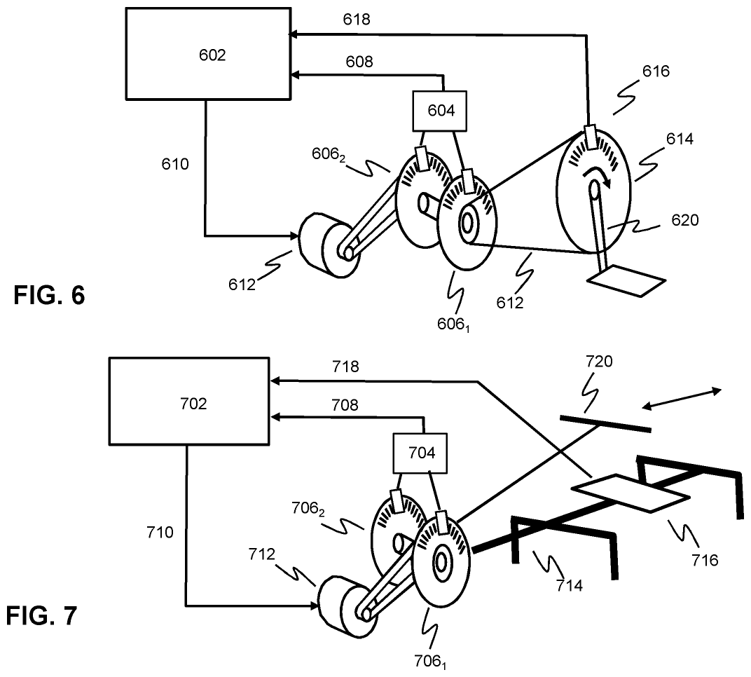

FIGS. 6 and 7 depict computer-controlled force feedback systems for an exercise apparatus according to various embodiments of the invention. In particular, both FIGS. 6 and 7 depict part of exercise apparatus comprising a computer 602,702 connected to an encoder system 602,702 that is configured to read out rotary positions of a first part 606₁,706₁ and second part 602₂,702₂ of a rotatable shaft, wherein the rotatable shaft comprises a spring structure of a predetermined spring behaviour, e.g. a predetermined spring constant. If a first torque is applied to the first part of the rotatable shaft, the encoder system generates position information 608,708 of the first and second part of the shaft and the computer uses this information in order to determine an angle of twist of the shaft. The computer may use the angle of twist to control a force generating device 612,712 by sending a feedback signal 610,710 to the force generating device to generate a second torque to the second part of the shaft. These elements are described in detail with reference to FIG. 1-3. Additionally, FIGS. 6 and 7 depict variants wherein the computer-controlled force feedback system includes a third encoder configured to measure third position information. In this case, the third position information may be associated with a position of a body part of the user of the exercise apparatus. For example, FIG. 6 depicts a variant wherein the exercise apparatus is a stationary exercise bike, wherein the rotatable shaft is part of the rear axis of the bike and wherein the first part of the shaft is connected to a gear, which is connected via a chain 612 to the chainwheel of the crank 614 of the bike. The third encoder 616 may have a readout structure in the form of a disc comprising position indicators positioned along periphery of the disc, wherein each position indicators determines a rotary position of the crank relative to a reference position of the crank. Thus, the third encoder may generate third position information 618 in the form of a periodic signal that is generated by a detector of the third encoder sequentially reading the position indicators when the user uses the exercise bike. The third position information may be used by the computer to determine the position of the crank and the pedals 620 and thus the position of the feet of the user during the exercise. In an embodiment, the computer may use the third position information for determining if a user of the exercise apparatus is freeriding. For example, the processor may instruct the force generating device to adjust the second torque based on the third position information if the third position information signals the processor that the user of the exercise apparatus is freewheeling.

In a similar way, FIG. 7 depicts a computer-controlled force feedback system for a rowing exercise apparatus. As shown in this figure, the rotatable shaft may be mounted on the frame 714 of the exercise apparatus. The frame may include a slidable seat 716 and a footrest structure connected to the frame. The first part of the shaft may be connected to a rotary mechanism including a chain or a cord connected to a handle 720 (representing the oar). The rotary mechanism of the rowing exercise apparatus is configured to enable a user to exercise strokes wherein each stroke includes a catch position (the start position), a drive phase wherein the user generates power up to the release (the end of the stroke) and a recovery phase wherein the rower slides back to the catch position. During the drive phase, the user exerts a force onto the first part of the shaft by a pull mechanism, during this phase the encoder system may provide position information of the first and second part of the shaft. Further, the third encoder may determine third position information 718 representing the position of the user during stroke actions to the computer and the computer will use this information to control a force generating device to exert a second torque on the shaft that is opposite to the first torque. Hence, the third encoder may be configured to determine for example the position of the slidable seat using a linear position encoder. The computer may use the position of the seat to determine if the user is in a catch, drive, release or recovery position and to control the force generating device accordingly.

FIGS. 8A and 8B depict a first and second cross sectional view of a shaft encoder structure according to an embodiment of the invention. In particular, FIG. 8A depicts an example of a rotatable shaft 800 including a torsion spring structure 802, preferably a spiral spring structure, between a first part 801₁ and second part 801₂ of the shaft, wherein a first encoder disc 808₁ and second encoder disc 808₂ are connected to the first and second part of the shaft respectively. At the first part, the shaft may be further connected to a gear 804, for rotatable connecting the shaft to e.g. a crank. The second part of the shaft may be connected to a gear or a driving wheel 806 for connecting the second part to a force generating device. Thus, the torsion spring structure connects the first part of the shaft to the second part of the shaft, so that if a torque is applied to the first and second part the spring structure may cause an angle of twist between the first and second part. The shaft encoder structure depicted in FIG. 8 is similar to the structure described with reference to FIG. 5 with the exception that the torsion spring has the shape of a spiral torsion spring 803, sometimes also referred to as a mainspring, e.g. a metal mainspring.

As shown in FIG. 8B, the spiral torsion spring may be contained in a (circular) enclosure 807. The spiral torsion spring may include an outer end 805₁ connected to the outer enclosure wherein the outer enclosure may be connected to the first part 801₁ of the shaft. For example, as shown in FIG. 8A, one side of the outer enclosure of the main spring may be fixed to the first encoder disc 808₁ that is connected to the first part of the shaft. Further, the spiral torsion spring may include an inner end 805₂ connected to the second part 801₂ of the shaft. The spring arrangement of FIGS. 8A and 8B provides a particular compact design wherein the spiral torsion spring can be designed such that it has a spring behaviour, e.g. a spring constant, for determining an angle of twist within a predetermined range. In one embodiment, a range between −20 and 20 degrees is selected. In another embodiment, a range between −10 and 10 degrees is selected.

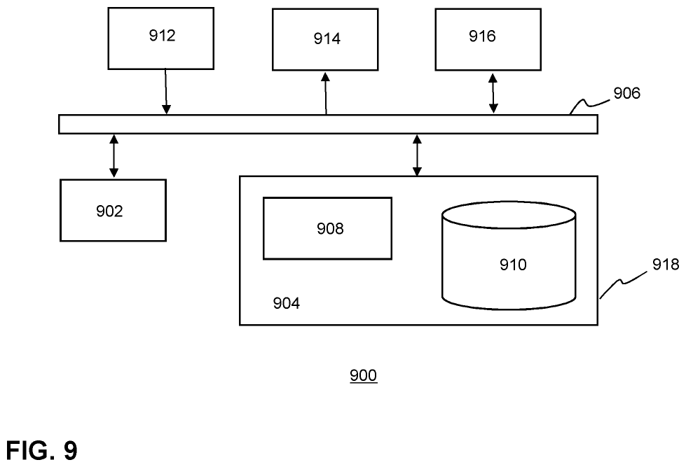

FIG. 9 is a block diagram illustrating an exemplary data processing system that may be used in as described in this disclosure. Data processing system 900 may include at least one processor 902 coupled to memory elements 904 through a system bus 906. As such, the data processing system may store program code within memory elements 904. Further, processor 902 may execute the program code accessed from memory elements 904 via system bus 906. In one aspect, data processing system may be implemented as a computer that is suitable for storing and/or executing program code. It should be appreciated, however, that data processing system 900 may be implemented in the form of any system including a processor and memory that is capable of performing the functions described within this specification.

Memory elements 904 may include one or more physical memory devices such as, for example, local memory 908 and one or more bulk storage devices 910. Local memory may refer to random access memory or other non-persistent memory device(s) generally used during actual execution of the program code. A bulk storage device may be implemented as a hard drive or other persistent data storage device. The processing system 1000 may also include one or more cache memories (not shown) that provide temporary storage of at least some program code in order to reduce the number of times program code must be retrieved from bulk storage device 910 during execution.

Input/output (I/O) devices depicted as input device 912 and output device 914 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening I/O controllers. A network adapter 916 may also be coupled to data processing system to enable it to become coupled to other systems, computer systems, remote network devices, and/or remote storage devices through intervening private or public networks. The network adapter may comprise a data receiver for receiving data that is transmitted by said systems, devices and/or networks to said data and a data transmitter for transmitting data to said systems, devices and/or networks. Modems, cable modems, and Ethernet cards are examples of different types of network adapter that may be used with data processing system 950.

As pictured in FIG. 9, memory elements 904 may store an application 918. It should be appreciated that data processing system 900 may further execute an operating system (not shown) that can facilitate execution of the application. Application, being implemented in the form of executable program code, can be executed by data processing system 900, e.g., by processor 902. Responsive to executing application, data processing system may be configured to perform one or more operations to be described herein in further detail.

In one aspect, for example, data processing system 900 may represent a client data processing system. In that case, application 918 may represent a client application that, when executed, configures data processing system 900 to perform the various functions described herein with reference to a “client”. Examples of a client can include, but are not limited to, a personal computer, a portable computer, a mobile phone, or the like. In another aspect, data processing system may represent a server. For example, data processing system may represent an (HTTP) server in which case application 918, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A torque sensing system comprising:
a rotatable shaft having a first part and a second part, the shaft comprising a spring structure between the first part and the second part;
a first readout structure connected to the first part, the first readout structure comprising first position indicators, and a second readout structure connected to the second part, the second readout structure comprising second position indicators;
a detector system for detecting the first and second position indicators and generating a first detection signal indicating respective passing times for the first position indicators and a second detection signal indicating respective passing times for the second position indicators; and,
a processor being configured for:
determining an angular position of the first readout structure occurring at a particular time instance based on a detected passing time of at least one first position indicator on the first readout structure and on a first relation between the angular position of the first readout structure and time around said particular time instance;
determining an angular position of the second readout structure occurring at the particular time instance based on a detected passing time of at least one second position indicator on the second readout structure; and,
determining an angle of twist at the particular time instance based on the angular position of the first readout structure and the angular position of the second readout structure, the angle of twist being associated with a torque applied to the first and/or second part of the rotatable shaft.

2. The torque sensing system according to claim 1, wherein the processor is configured for determining said first relation wherein the step of determining said first relation is performed based on at least two detected passing times of at least two respective first position indicators on the first readout structure.

3. The torque sensing system according to claim 1,
wherein the first readout structure comprises a first reference indicator and the detector system is suitable for detecting the first reference indicator and wherein the step of determining said angular position of the first readout structure occurring at said particular time instance comprises counting a number of said first position indicators that pass by since a detected passing time of the first reference indicator; and/or,
wherein the second readout structure comprises a second reference indicator and the detector system is suitable for detecting the second reference indicator.

4. The torque sensing system according to claim 1, wherein
the particular time instance lies between two detected passing times of two respective first position indicators, or wherein
the particular time instance lies after the most recently detected passing time of a first position indicator.

5. The torque sensing system according to claim 1, wherein said first relation is a linear relation between angular position and time.

6. The torque sensing system according to claim 1, wherein a physical model is used to model the behaviour of the system attached to either or both sides of the torque sensing system, the parameters from that system being determined through curve fitting through any number of measurement combinations, and the physical model then being used to predict the rotary position of the readout structure.

7. The torque sensing system according to claim 1, wherein the spring structure is configured to provide a maximum angle of twist which is larger than the rotary angle between two subsequent of said position indicators of the first and second readout structure.

8. The torque sensing system according to claim 1, wherein the spring structure is configured to provide an angle of twist between −20 and 20 degrees.

9. The torque sensing system according to claim 1, wherein the spring structure comprises a torsion spring.

10. The torque sensing system according to claim 1, wherein each of the first position indicators is associated with a unique code, the processor being further configured to determine an absolute rotary position for each position indicator based on the associated unique code.

11. The torque sensing system according to claim 1, wherein the first readout structure includes a disc connected to the first part of the shaft, the first position indicators are positioned along one or more circular paths on the first disc; and/or, the second readout structure includes a second disc connected to the second part of the shaft, and wherein the second position indicators are positioned along one or more circular paths on the second disc.

12. The torque sensing system according to claim 1, wherein the detector system comprises one or more imaging sensors for imaging the position indicators and/or an optical detector and/or a magnetic detector and/or a capacitive detector.

13. A force feedback system for an exercise apparatus comprising:
a torque sensing system according to claim 1;
a force generating device connected to the second part of the rotatable shaft;
a computer comprising a processor configured to:
in response to a first torque applied to the first part of the rotatable shaft, receiving one or more values representing a torque measured by the torque sensing system; and
computing a control signal for the force generating device, the control signal instructing the force generating device to exert a second torque to the second end of the shaft, the second torque being opposite to the first torque.

14. A computer-implemented method for determining an angle of twist, wherein
a torque sensing system comprises a rotatable shaft has a first part and a second part, the shaft comprising a spring structure between the first part and the second part; and wherein the torque sensing system comprises
a first readout structure connected to the first part, the first readout structure comprising first position indicators, and a second readout structure connected to the second part, the second readout structure comprising second position indicators; and wherein the torque sensing system comprises
a detector system for detecting the first and second position indicators and generating a first detection signal indicating respective passing times for the first position indicators and a second detection signal indicating respective passing times for the second position indicators; the computer-implemented method comprising
receiving said first and second detection signals, from the detector system;
determining an angular position of the first readout structure occurring at a particular time instance based on a detected passing time of at least one first position indicator on the first readout structure and on a first relation between the angular position of the first readout structure and time around said particular time instance;
determining an angular position of the second readout structure occurring at the particular time instance based on a detected passing time of at least one second position indicator on the second readout structure; and,
determining an angle of twist at the particular time instance based on the angular position of the first readout structure and the angular position of the second readout structure, the angle of twist being associated with a torque applied to the first and/or second part of the rotatable shaft.

15. Computer program product comprising software code portions configured for, when run in the memory of a computer, executing the method according to claim 14.

16. The torque sensing system of claim 1 wherein the angular position of the second readout structure occurring at the particular time instance is further determined based on a second relation between angular position of the second readout structure and time around said particular time instance.

17. The torque sensing system of claim 2, wherein the processor is further configured for determining said second relation and wherein the step of determining said second relation is performed based on at least two detected passing times of at least two respective second position indicators on the second readout structure.

18. The torque sensing system of claim 3, wherein the step of determining said angular position of the second readout structure occurring at said particular time instance comprises counting a number of second position indicators that pass by since a detected passing time of the second reference indicator.

19. The torque sensing system of claim 4, wherein the angular position of the first readout structure being determined based on said two detected passing times.

20. The torque sensing system of claim 5, wherein said second relation is a linear relation between angular position and time.
